(19) United States
(12) Patent Application Publication
(10) Pub. No.: US 2005/0249286 A1
(43) Pub. Date: Nov. 10, 2005

(54) Method and device for generating candidate vectors for image interpolation systems

(75) Inventor: Marina Nicolas, Voreppe (FR)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: STMICROELECTRONICS SA, MONTROUGE (FR)

(21) Appl. No.: 11/117,063

(22) Filed: Apr. 28, 2005

(30) Foreign Application Priority Data
Apr. 29, 2004 (FR) 04 04571

(51) Int. Cl. H04N 7/12

(52) U.S. Cl. 375/240.16; 375/240.12; 375/240.24

(57) ABSTRACT

A motion estimation method and device are provided for processing images to be inserted, between a preceding original image and a following original image, in a sequence of images. Each of the images is divided into several pixel blocks. A motion vector is associated with each block of a processed image. For a current block of an image currently being processed, motion vectors associated with blocks of the image currently being processed and/or of an already processed image are selected. For each motion vector selected, an updating vector is determined. Candidate vectors are generated from the selected motion vectors and the updating vectors. A vector is elected from among the candidate vectors. Information associating the elected motion vector with the current block is stored in memory. The updating vector is determined on the basis of a calculated confidence value stored in memory for each associated motion vector.

### CROSS-REFERENCE TO RELATED APPLICATIONS

This application is based upon and claims priority from prior French Patent Application No. 04 04571, filed Apr. 29, 2004, the entire disclosure of which is herein incorporated by reference.

### FIELD OF THE INVENTION

The present invention relates to the field of sequential image display, and more precisely to image processing methods for encoding images or inserting images within a sequence of images of the video or film type.

### BACKGROUND OF THE INVENTION

In certain video or film image processing systems, the image rate (number of images per second) is insufficient for high-quality display. Consequently, additional images are generated via an interpolation function and displayed between original images in order to increase the image rate and improve the quality of the display. An interpolation function of this type conventionally calculates the value of the pixels of an interpolated image, in particular as a function of the value of the pixels of the preceding original image and/or the value of the pixels of the following original image.

Such an interpolation function is based on the correlation that exists between successive images of a video or film. This is because, in a sequence of video images, subjects that are moving generally appear in different respective regions of several consecutive images. Interpolated images are therefore generated from parts of preceding and/or following original images.

Conventionally, an image is divided into pixel blocks and the assumption is made that each block is substantially identical from one image to another even if there is motion of this block between two images. Consequently, an image is interpolated from original images by seeking, for each current block of the image being interpolated, that one of the blocks of a preceding original image and/or a following original image that is the most probable.

Motion estimation and/or compensation methods offer block searching methods thus adapted for generating interpolated images. A correlation between those parts of the consecutive images in which a moving object appears may in fact be expressed via a motion vector. The motion vector represents the motion of a pixel block from one image to the other. It has a vertical component and a horizontal component, representing the displacement that has to be applied to a block of a preceding image in order to arrive at the position of a substantially identical pixel block in a following image.

Such methods are conventionally used in video data compression systems, such as systems based on the MPEG standard. Such systems are used to reduce the quantity of image data to be transmitted or stored, by compressing this data so as to allow it to be rapidly transferred to digital networks or even telephone lines, or to allow it to be recorded on digital media. Consequently, only certain reference images are encoded and transmitted, and then, on the receive side, the missing intermediate images are interpolated according to the motion vectors transmitted with the encoded images.

In such systems, on the transmit side, the intermediate image is processed so as to transmit the least possible amount of information, as mentioned above. Thus, the intermediate image is divided into blocks. For each block, a correlation is calculated between the current block and a selection of candidate blocks belonging to a preceding and/or following reference image or intermediate image already processed. This correlation calculation delivers an error relating to each candidate block. A candidate block is then elected, in order to represent the current block of the intermediate image. The elected candidate block is that one having the highest correlation with the current block (i.e., the lowest error). To allow interpolation of the intermediate images on the receive side, since the processed image is not transmitted as such, there is transmitted the following information, which is generally transmitted relative to each current block of an image to be interpolated:
an indication of the candidate block elected;
a motion vector representing a displacement of the candidate block elected to the position of the current block; and
an error delivered by the correlation calculation.

Thus, on the receive side, the missing images are interpolated on the basis of the information received with the encoded reference images. This interpolation comprises the determination of a value of the pixels of each block of these missing images. The term “reference images” is equivalent to the term “original images”.

Certain interlaced image display systems also use motion estimation and/or compensation methods.

Image rate conversion devices also employ such methods. Such devices make it possible in fact to increase an original image rate by generating additional images obtained by interpolation of the original images. These devices are conventionally used to adapt the image rates between, on the one hand, an image generation, encoding, transmission and/or storage system and, on the other hand, an image display system, which involve different image rates.

In such devices, the image to be interpolated is divided into blocks. Candidate vectors are generated for each of the blocks. For each of the candidate vectors, a block in the preceding original image and a block in the following original image are selected, each one corresponding to a displacement of the position of the current block relative to the candidate vector. The correlation between the selected block of the preceding image and the selected block of the following image is calculated. The motion vector giving the highest correlation is elected. The current block is then interpolated on the basis of the block in the preceding original image and the block in the following original image that are determined by the candidate vector elected.

The term “processed image” refers to images divided into a plurality of blocks for which a motion vector has been elected. Thus, interpolated images are generated by interpolation of the processed images.

The next section presents basic concepts conventionally used in motion estimation methods. It is common practice to distinguish several types of images: original images of type I (intra images) which are encoded without reference to other images; images of type P (predictive images) which are interpolated via a motion estimation algorithm on the basis of a preceding original image; and images of type B (bidirectional images) which are interpolated via a motion estimation algorithm based on a preceding original image and on a following original image.

As described above, a motion estimation relies on the assumption that a pixel block of the image currently being processed can be modeled as a displacement of a pixel block of the preceding original image and/or a pixel block of the following image. In such a model, it is therefore assumed that each pixel of any one pixel block undergoes substantially the same displacement. A motion vector associated with each pixel block of a processed image represents this displacement movement. Then, by applying a respective displacement corresponding to the associated motion vector to each of the pixel blocks of the preceding original image and/or to each of the pixel blocks of the following original image, each current block of the image currently being processed is generated.

Motion estimation methods are known which, for a current block of an image currently being processed, candidate vectors are generated from motion vectors already associated with pixel blocks of already processed images, or else already associated with pixel blocks neighboring the current pixel block of the image currently being processed. Such methods are consequently of the iterative type.

One of the problems with iterative methods is the phenomenon of convergence. Specifically, such an iterative-type method cannot converge when it associates a motion vector with a current pixel block while this motion vector does not give a high correlation for that pixel block. This may occur in particular when, among the candidate motion vectors selected for a pixel block, none gives a satisfactory correlation. In general, in this case the candidate motion vector having the highest relative correlation is elected, in order to be associated with the pixel block. Thus, motion vectors not giving a high absolute correlation may be associated with pixel blocks and thus may then be selected as candidate motion vectors for other pixel block processing operations. This “snowball” effect of an iterative method may result in such a method diverging critically.

To avoid such a problem, motion estimation methods have been proposed that generate candidate vectors from motion vectors already associated with pixel blocks, with random updating vectors being added thereto. Thus, a random component is introduced into the candidate vectors relating to a current pixel block, which promotes convergence in iterative methods.

### SUMMARY OF THE INVENTION

It is an object of the present invention to provide improved convergence in motion estimation methods.

One embodiment of the present invention provides a motion estimation method for processing images to be inserted between a preceding original image and a following original image in a sequence of determined images. Each of the images is divided into a plurality of pixel blocks, and a motion vector is associated with each of the pixel blocks of a processed image. According to the method, for a current pixel block of an image currently being processed, there are selected motion vectors comprising motion vectors associated with determined pixel blocks of the image currently being processed and/or motion vectors associated with determined pixel blocks of an already processed image. For each of the motion vectors thus selected, an associated updating vector is determined, and candidate motion vectors are generated, with each being defined on the basis of a selected motion vector and the associated updating vector. A motion vector is elected from among the candidate motion vectors, and information associating the elected motion vector with the current pixel block is stored in memory. A confidence value for each motion vector associated with a block is calculated and stored in memory, and the updating vector is determined on the basis of the respective confidence value.

Another embodiment of the present invention provides a motion estimation device for processing images to be inserted between a preceding original image and a following original image in a sequence of determined images. Each of the images is divided into a plurality of pixel blocks, and a motion vector is associated with each of the pixel blocks of a processed image. The device includes a selection unit, a determination unit, a generation unit, an election unit, and a memory. The selection unit selects motion vectors comprising motion vectors associated with pixel blocks of the image currently being processed and/or motion vectors associated with determined pixel blocks of an already processed image. The determination unit determines an associated updating vector for each of the selected motion vectors, and the generation unit generates candidate motion vectors, each of which is defined on the basis of a selected motion vector and the associated updating vector. The election unit elects a motion vector from among the candidate motion vectors, and the memory stores information associating the elected motion vector with the current pixel block. The device further includes a unit for calculating and storing in memory a confidence value for each motion vector associated with a block. The determination unit determines the updating vector on the basis of the respective confidence value.

Yet another embodiment of the present invention provides a computer program product that can be loaded directly into the internal memory of a digital computer. The computer program product includes software code portions for executing the steps of a method according to an embodiment of the present invention when the program is run on the computer.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a flow chart illustrating steps of a method according to one embodiment of the present invention;

FIG. 2 is a diagram illustrating a motion estimation method according to one embodiment of the present invention; and

FIG. 3 illustrates a correlation calculation for a processed image on the basis of the preceding and following original images.

### DETAILED DESCRIPTION OF PREFERRED EMBODIMENTS

Preferred embodiments of the present invention will be described in detail hereinbelow with reference to the attached drawings.

As described above, a motion vector associated with a given block of pixels of a processed image, or of one currently being processed, represents the displacement of each pixel of the block from a preceding original image to an image currently being processed, or from the image currently being processed to the following original image. It should be noted that this movement representation is in fact only approximate. It follows therefore that certain pixels of the current block thus displaced do not appear in the preceding original image and/or the following original image. Occasionally a motion vector associated with a block proves to be very unreliable as far as representing the actual movement of the set of pixels of the block. It would therefore seem to be judicious for the method not to be based directly on values of motion vectors that are of low reliability, which are already associated with pixel blocks, for generating candidate vectors for a pixel block currently being processed.

In one embodiment of the present invention, when a motion vector is associated with a block, a confidence value is determined for this motion vector. Thus, the candidate motion vectors may advantageously be generated by taking into consideration the confidence value of the motion vectors.

Preferred embodiments of the present invention also generate candidate motion vectors from motion vectors already associated with pixel blocks of processed images, or blocks of images currently being processed, by adding to them an updating vector determined on the basis of the confidence value that relates to the motion vector.

FIG. 1 illustrates steps carried out for each pixel block of an image currently being processed in a method according to one embodiment of the present invention. Motion vectors associated with blocks of an image already processed, or already associated with blocks of an image currently being processed, are selected in step 11. Next, for each of these selected motion vectors, an updating vector is determined in step 12 on the basis of the confidence value of the respective motion vector. Next, candidate motion vectors are generated from the selected motion vectors and from their respective updating vector in step 13. Next, the motion vector most suitable for the block currently being processed is elected from among the generated candidate motion vectors in step 14. Information associating the elected motion vector with the pixel block currently being processed is stored in memory in step 15.

For each of the pixel blocks of a processed image, a motion vector and a respective confidence value are thus determined and stored in memory. The following sections describe these various steps in greater detail.

Thus, in one embodiment of the present invention, for each current block of an image currently being processed, motion vectors already associated with blocks of a previously processed image and/or neighboring blocks in the image currently being processed are selected in step 11. A confidence value corresponding to each of these selected motion vectors is determined.

An updating vector of relatively low norm is added to a motion vector to which a relatively high confidence value corresponds, that is to say a motion vector giving a relatively reliable representation of the movement of the set of pixels of the block with which it is associated.

Conversely, an updating vector of relatively high norm is added to a motion vector to which a relatively low confidence value corresponds, that is to say a motion vector giving a relatively unreliable representation of the movement of the set of pixels of the block with which it is associated.

FIG. 2 illustrates the principle of one exemplary implementation of such an iterative method in which motion vectors are selected from among the motion vectors associated with respective pixel blocks of the image currently being processed and the motion vectors associated with respective pixel blocks of an image already processed, which are called “spatial motion vectors” and “temporal motion vectors”, respectively. An already processed image 100 is considered to comprise nine pixel blocks 101-109 with each of which a respective motion vector V1-V9 is associated. An image 110 currently being processed comprises nine pixel blocks 111-119, among which the blocks 111-114 have already been processed and the block 115 is currently being processed. A motion vector and a confidence value for each pixel block already processed are stored in a suitable memory. Thus, in the case of the blocks 101-114, the motion vectors V1-V14 and the respective confidence values f1-f14 are stored in memory.

In one embodiment of the present invention, the confidence value results from calculating the correlation between, on the one hand, the values of the pixels of a first pixel block in the preceding original image and indicated by the candidate motion vector from the positions of the pixels of the current pixel block to be processed and, on the other hand, the values of the pixels of a second pixel block in the following original image and indicated by the candidate motion vector from the positions of the pixels of the current pixel block to be processed. This correlation calculation provides an error value associated with the motion vector that is associated with the pixel block. This embodiment is particularly suited to image rate conversion systems.

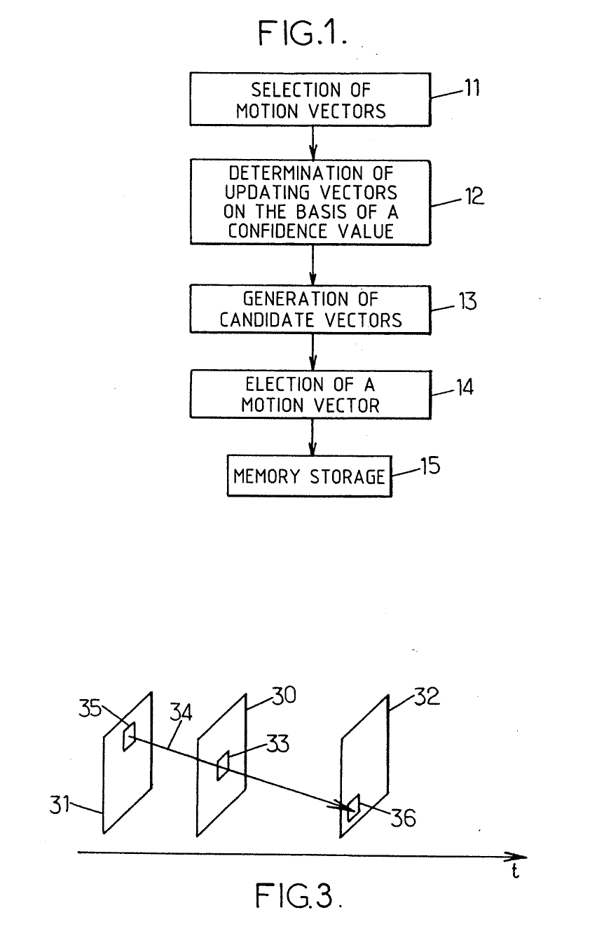

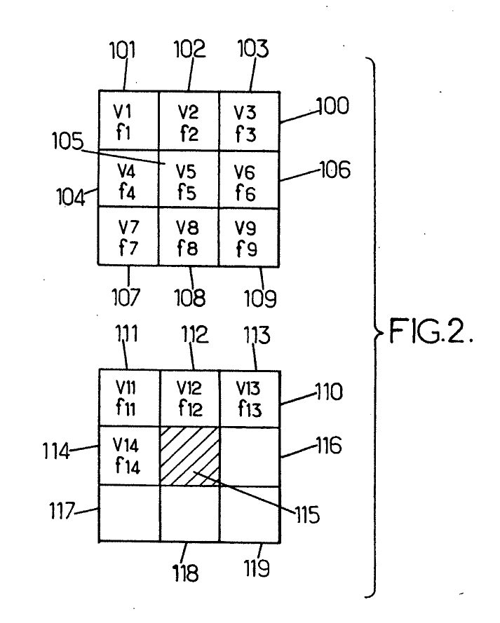

FIG. 3 illustrates such a correlation calculation. A correlation calculation for a candidate vector 34 relating to a current block 33 of an image 30 currently being processed is carried out. This calculation is carried out on the basis of the values of the pixels of a first pixel block 35 in the original image 31 and indicated by the candidate vector 34 from the positions of the current block 33 and the values of the pixels of a pixel block 36 in the original image 32 indicated by the candidate vector 34 from the positions of the pixels of the current block 33.

In another embodiment of the present invention, the confidence value is derived from an error calculated, for each of the candidate motion vectors, on the basis of a correlation between the values of the pixels of the current block and the values of the pixels of a pixel block in the preceding and/or following image indicated by the candidate vector. This embodiment is particularly suited to compression systems. In such a system, during the step of associating a motion vector with the current block, the values of the pixels of the current block are available, this step being carried out, on the transmit side, before the images are transmitted. It is therefore possible to calculate a correlation on the basis of the values of the pixels that make up the current block itself.

The present invention is not limited to these confidence value examples.

Preferably, the updating vector has a random direction and is therefore independent of the confidence value, whereas the norm of the updating vector depends on the confidence value with which it is associated.

In one embodiment of the present invention, the lower the confidence value, the higher the norm of the updating vector, and vice versa.

Candidate vectors that are more suitable for a current block and result in better convergence of the method are thus generated from the selected motion vectors.

In one embodiment of the present invention, after candidate vectors for a current block have thus been generated, a confidence value is determined for each of these candidate vectors. Preferably, the confidence value corresponds to a correlation error, as described above.

A motion vector for the current block is then elected. The motion vector elected from among the candidate vectors generated is that one for which the confidence value is the highest or the correlation error is the lowest.

Next, information indicating the association of the current block with the elected motion vector, and also the confidence value determined for this candidate vector, for the current block, are stored in memory.

In one embodiment of the present invention the confidence value is encoded over two bits.

Next, the processed image is interpolated by determining values of the pixels of the current block according to the values of the pixels in the preceding original image that are indicated by the elected motion vector from the positions of the pixels of the current pixel block to be interpolated and/or according to the values of the pixels in the following original image that are indicated by the motion vector elected from the positions of the pixels of the current pixel block to be interpolated.

Very good results are obtained with regard to the rate of convergence of the method. In addition, the present invention can be implemented very simply.

The present invention allows better rendering of the image with regard to rapid movements and better performance uniformity in the sequence of images. It may advantageously be implemented in systems such as those defined above, with the image rendering being improved.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

1. A motion estimation method for processing images intended to be inserted, between a preceding original image and a following original image, into a sequence of images, each of the images being divided into a plurality of pixel blocks, and a motion vector being associated with each of the pixel blocks of a processed image, the method comprising, for a current pixel block of an image currently being processed, the steps of:
selecting motion vectors comprising motion vectors associated with pixel blocks of the image currently being processed and/or motion vectors associated with pixel blocks of an already processed image;
calculating and storing a confidence value for each motion vector that is associated with a pixel block;
determining an associated updating vector for each of the selected motion vectors;
generating candidate motion vectors that are each defined based on one of the selected motion vectors and the associated updating vector;
electing a motion vector from among the candidate motion vectors; and
storing information associating the elected motion vector with the current pixel block,
wherein in the determining step, the associated updating vector is determined based on the confidence value for the selected motion vector.

2. The method according to claim 1, wherein in the calculating and storing step, the confidence value is an error value calculated based on a correlation between the values of the pixels of a first pixel block in the preceding original image that are indicated by a given candidate motion vector from the positions of the pixels of the current pixel block to be processed and/or the values of the pixels of a second pixel block in the following original image that are indicated by a given candidate motion vector from the positions of the pixels of the current pixel block to be processed.

3. The method according to claim 1, wherein in the calculating and storing step, the confidence value is derived from an error calculated on the basis of a correlation between the values of the pixels of the current pixel block and the values of the pixels of a pixel block given in the preceding and/or following image that are indicated by a given candidate motion vector.

4. The method according to claim 1, wherein in the determining step, the norm of the updating vector is determined according to the confidence value for the selected motion vector, with its direction determined randomly.

5. The method according to claim 1,
wherein the lower the confidence value, the higher the norm of the updating vector, and
the higher the confidence value, the lower the norm of the updating vector.

6. The method according to claim 1, wherein in the electing step, the candidate motion vector for which the confidence value is the highest is elected.

7. The method according to claim 1, further comprising the step of interpolating the processed image by determining pixel values of the current pixel block according to the values of the pixels in the preceding original image that are indicated by the elected motion vector from the positions of the pixels of the current pixel block to be interpolated and/or according to the values of the pixels in the following original image that are indicated by the elected motion vector from the positions of the pixels of the current pixel block to be interpolated.

8. A motion estimation device for processing images intended to be inserted, between a preceding original image and a following original image, in a sequence of images, each of the images being divided into a plurality of pixel blocks, and a motion vector being associated with each of the pixel blocks of a processed image, the device comprising, with respect to a current pixel block of an image currently being processed:
a selection unit for selecting motion vectors comprising motion vectors associated with pixel blocks of the image currently being processed and/or motion vectors associated with pixel blocks of an already processed image;
a calculation unit for calculating a confidence value for each motion vector that is associated with a pixel block;
a determination unit for determining an associated updating vector for each of the selected motion vectors;
a generation unit for generating candidate motion vectors that are each defined based on one of the selected motion vectors and the associated updating vector;
an election unit for electing a motion vector from among the candidate motion vectors; and
a memory for storing information associating the elected motion vector with the current pixel block,
wherein the determination unit determines the associated updating vector based on the confidence value for the selected motion vector.

9. The device according to claim 8, wherein the calculation unit calculates the confidence value as an error from a correlation between the values of the pixels of a first pixel block in the preceding original image that are indicated by a given candidate motion vector from the positions of the pixels of the current pixel block to be processed and/or the values of the pixels of a second pixel block in the following original image that are indicated by a given candidate motion vector from the positions of the pixels of the current pixel block to be treated.

10. The device according to claim 8, wherein the calculation unit derives the confidence value from an error calculated based on a correlation between the values of the pixels of the current pixel block and the values of the pixels of a pixel block in the preceding and/or following image that are indicated by a given candidate motion vector.

11. The device according to claim 8, wherein the determination unit determines the norm of the updating vector based on the confidence value for the selected motion vector, with its direction determined randomly.

12. The device according to claim 8, wherein the determination unit determines the norm of the updating vector such that the lower the confidence value, the higher the norm of the updating vector, and the higher the confidence value, the lower the norm of the updating vector.

13. The device according to claim 8, wherein the election unit elects the candidate motion vector for which the confidence value is the highest.

14. A computer program product encoded with a program for processing images intended to be inserted, between a preceding original image and a following original image, into a sequence of images, each of the images being divided into a plurality of pixel blocks, and a motion vector being associated with each of the pixel blocks of a processed image, the program including instructions for performing, for a current pixel block of an image currently being processed, the steps of:
selecting motion vectors comprising motion vectors associated with pixel blocks of the image currently being processed and/or motion vectors associated with pixel blocks of an already processed image;
calculating and storing a confidence value for each motion vector that is associated with a pixel block;
determining an associated updating vector for each of the selected motion vectors;
generating candidate motion vectors that are each defined based on one of the selected motion vectors and the associated updating vector;
electing a motion vector from among the candidate motion vectors; and
storing information associating the elected motion vector with the current pixel block,
wherein in the determining step, the associated updating vector is determined based on the confidence value for the selected motion vector.

15. The computer program product according to claim 14, wherein in the calculating and storing step, the confidence value is an error value calculated based on a correlation between the values of the pixels of a first pixel block in the preceding original image that are indicated by a given candidate motion vector from the positions of the pixels of the current pixel block to be processed and/or the values of the pixels of a second pixel block in the following original image that are indicated by a given candidate motion vector from the positions of the pixels of the current pixel block to be processed.

16. The computer program product according to claim 14, wherein in the calculating and storing step, the confidence value is derived from an error calculated on the basis of a correlation between the values of the pixels of the current pixel block and the values of the pixels of a pixel block given in the preceding and/or following image that are indicated by a given candidate motion vector.

17. The computer program product according to claim 14, wherein in the determining step, the norm of the updating vector is determined according to the confidence value for the selected motion vector, with its direction determined randomly.

18. The computer program product according to claim 14, wherein in the electing step, the candidate motion vector for which the confidence value is the highest is elected.
